(19) United States
(12) Patent Application Publication
(10) Pub. No.: US 2012/0152361 A1
(43) Pub. Date: Jun. 21, 2012

(54) Inertia Enhanced Pumping Mechanism And Method

(76) Inventors: Justin C. Williams, Cambridge, WI (US); David J. Beebe, Monona, WI (US); Pedro Resto, Madison, WI (US); Erwin Berthler, Madison, WI (US)

(21) Appl. No.: 12/973,188

(22) Filed: Dec. 20, 2010

(51) Int. Cl. F15D 1/00

(52) U.S. Cl. 137/1; 137/806

(57) ABSTRACT

A device and method are provided for pumping fluid through a channel of a microfluidic device. The channel has an input and an output. The channel is filled with fluid and droplets under pressure are sequentially directed at the input of the channel so as to cause fluid to flow in the channel towards the output.

### REFERENCE TO GOVERNMENT GRANT

This invention was made with United States government support under W81XWH-04-1-0572 awarded by the ARMY/MRMC. The United States government has certain rights in the invention.

The United States government has certain rights to this invention.

### FIELD OF THE INVENTION

This invention relates generally to fluid flow within channels of microfluidic devices, and in particular, to an inertia enhanced pumping mechanism for fluid flow and backflow in a channel of a microfluidic device.

### BACKGROUND AND SUMMARY OF THE INVENTION

Several non-traditional pumping methods have been developed for pumping fluid through a channel of a microfluidic device, including some which have displayed promising results. However, the one drawback to almost all pumping methods is the requirement for expensive or complicated external equipment, be it the actual pumping mechanism (e.g., syringe pumps), or the energy to drive the pumping mechanism (e.g., power amplifiers). The ideal device for pumping fluid through a channel of a microfluidic device would be semi-autonomous and would be incorporated totally at the microscale.

The most popular method of moving a fluid through a channel of a microfluidic device is known as electrokinetic flow. Electrokinetic flow is accomplished by conducting electricity through the channel of the microfluidic device in which pumping is desired. While functional in certain applications, electrokinetic flow is not a viable option for moving biological samples through a channel of a microfluidic device. The reason is twofold: first, the electricity in the channels alters the biological molecules, rendering the molecules either dead or useless; and second, the biological molecules tend to coat the channels of the microfluidic device rendering the pumping method useless.

In addition, as biological experiments become more complex, an unavoidable fact necessitated by the now apparent complexity of genome-decoded organisms, is that more complex tools will be required. Presently, in order to simultaneously conduct multiple biological experiments, plates having a large number (e.g. either 96 or 384) of wells are often used. The wells in these plates are nothing more than holes that hold liquid. While functional for their intended purpose, it can be appreciated that these multi-well plates may be used in conjunction with or may even be replaced by microfluidic devices. To take advantage of existing hardware, “sipper” chips have been developed. Sipper chips are microfluidic devices that are held above a traditional 96 or 384 well plate and sip sample fluid from each well through a capillary tube. While compatible with existing hardware, sipper chips add to the overall complexity, and hence, to the cost of production of the microfluidic devices.

In order to overcome the limitations of these prior devices, a method of surface tension passive pumping has been developed. As fully described in Beebe, U.S. Pat. No. 7,189,580, surface tension passive pumping is a method for inducing fluid flow in a microfluidic channel which relies on the pressure differential between a small drop and a large one to produce flow in the channel. The Beebe '580 is assigned to the assignee of the present invention and incorporated herein by reference. Surface tension passive pumping has garnered significant interest among investigators since it does not require external tubing or bonding to a substrate of the microfluidic device. While functional for its intended purpose, the surface tension passive pumping methodology disclosed in the '580 patent has certain limitations. By way of example, the range of flow rates of the fluid flowing through the channel of the microfluidic device is somewhat limited. As a result, in those applications where relatively high flow rates and/or fast exchange times are desired, the methodology disclosed in the '580 patent may be inadequate. Hence, it is highly desirable to provide a method of surface tension pumping which provides for higher flow rates than prior methods.

Therefore, it is a primary object and feature of the present invention to provide a device and method for the surface tension pumping of fluid through a channel of a microfluidic device that allows for greater flow rates than previously obtained.

It is a further object and feature of the present invention to provide a device and method for the surface tension pumping of fluid through a channel of a microfluidic device, which is simple and inexpensive.

It is a still object and feature of the present invention to provide a device and method for the surface tension pumping of fluid through a channel of a microfluidic device, which is semi-autonomous and requires only minimal additional hardware.

It is a still further object and feature of the present invention to provide a device and method for the surface tension pumping of fluid through a channel of a microfluidic device which is compatible with preexisting robotic high throughput equipment.

In accordance with the present invention, a device is provided for the surface tension pumping of fluid though a channel of a microfluidic device. The channel includes an input and an output. The device includes a fluid received in the channel. The fluid has an input air-fluid interface at the input of the channel and an output air-fluid interface at the output of the channel. A fluid jet is provided at a user selected angle to the input air-fluid interface. The fluid jet selectively directs a droplet under pressure at the input air-fluid interface of the fluid so as to cause fluid to flow in the channel towards the output.

The fluid jet may be a first fluid jet and the device may also include a second fluid jet at a user selected angle to the output air-fluid interface. The second fluid jet selectively directs a droplet under pressure at the output air-fluid interface of the fluid so as to cause fluid to flow in the channel towards the input. It is contemplated for the input and the output of the channel to lie in corresponding planes and for the first fluid jet to be at an angle of less than 90 degrees to the plane of the input and the second fluid jet is at an angle of less than 90 degrees to the plane of the output.

The input of the channel lies in a plane and the fluid jet is at an angle of less than 90 degrees to the plane. The droplet is a first droplet and it is intended for the fluid jet to direct a series of droplets under pressure at the input air-fluid interface of the fluid. In addition, the fluid jet may be a first fluid jet and the device may also include a second fluid jet at a user selected angle to the input air-fluid interface. The second fluid jet also directs a droplet under pressure at the input air-fluid interface of the fluid. It is intended for the droplet directed by the first fluid jet to be spaced in time from the droplet directed by the second jet. The fluid jets may include nozzles spaced from the input air-fluid interface.

In accordance with a further aspect of the present invention, a method of pumping fluid is provided. The method includes the steps of providing a microfluidic device having a channel therethough. The channel has an input and an output. The channel is filled with fluid and a droplet is selectively directed under pressure at the input of the channel so as to cause fluid to flow in the channel towards the output.

The method may include the additional step of selectively directing a droplet under pressure at the output of the channel so as to cause fluid to flow in the channel towards the input. The input and output of the channel lie in corresponding planes and the droplet directed at the input travels along an axis at an angle of less than 90 degrees to the plane of the input and the droplet directed at the output travels along an axis at an angle of less than 90 degrees to the plane of the output.

The droplet may be a first droplet and the method may include the additional step of directing a series of droplets under pressure at the input of the channel. It is contemplated for the first droplet to be directed by a first fluid jet and for the method to include the additional step of selectively directing a second droplet under pressure at the input of the channel by a second fluid jet. It is intended for the first droplet directed by the first fluid jet to be spaced in time from the second droplet directed by the second fluid jet.

In accordance with a still further aspect of the present invention, a method of pumping fluid through a channel of a microfluidic device is provided. The channel has an input and an output. The method includes the step of filling the channel with a first fluid such that the first fluid at the input has a surface tension pressure. Thereafter, a volume of a second fluid is selectively directed under pressure at the input of the channel so as to cause fluid in the channel to flow towards the output.

The step of selectively directing a volume of the second fluid under pressure at the input of the channel may include the step of sequentially directing a plurality of droplets under pressure at the input of the channel. In addition, a plurality of droplet under pressure may be selectively directed at the output of the channel so as to cause fluid in the channel to flow towards the input. The input and output of the channel lie in corresponding planes and each droplet directed at the input travels along an axis at an angle of less than 90 degrees to the plane of the input. Similarly, each droplet directed at the output travels along an axis at an angle of less than 90 degrees to the plane of the output.

Each droplet directed under pressure at the input of the channel is directed by a first fluid jet. A second plurality of droplets under pressure may be selectively directed at the input of the channel by a second fluid jet. Each droplet directed by the first fluid jet is spaced in time from each droplet directed by the second fluid jet.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic, top plan view of a device for the surface tension pumping of fluid through a channel in accordance with the present invention;

FIG. 2 is a side elevational view of a portion of the device of FIG. 1;

FIG. 3 is an enlarged, side elevational view of the device taken along line 3-3 of FIG. 2;

FIG. 4 is a side elevational view, similar to FIG. 2, showing a droplet of liquid being directed toward the input of the channel of the device of FIG. 1;

FIG. 5 is a side elevational view, similar to FIGS. 2 and 4, showing the droplet of liquid flowing into the channel of the device of FIG. 1;

FIG. 6 is a side elevational view, similar to FIGS. 2 and 4-5, showing the droplet of liquid flowing further into the channel of the device of FIG. 1; and

FIG. 7 is a side elevational view, similar to FIGS. 2 and 4-6, showing an alternate embodiment of the device of FIG. 1.

### DETAILED DESCRIPTION OF THE DRAWINGS

Referring to FIGS. 1-7, a microfluidic device for use in the method of the present invention is generally designated by the reference numeral 10. Microfluidic device 10 may be formed from polydimethylsiloxane (PDMS) or similar material, and has first and second ends 12 and 14, respectively, and upper and lower surfaces 18 and 20, respectively. Channel 22 extends through microfluidic device 10 and includes a first vertical portion 26 terminating at an input 28 that communicates with upper surface 18 of microfluidic device 10 and a second vertical portion 30 terminating at an output 32 also communicating with upper surface 18 of microfluidic device 10. First and second vertical portions 26 and 30, respectively, of channel 22 are interconnected by and communicate with horizontal portion 33 of channel 22. The dimensions of channel 22 connecting input 28 and output 32 are arbitrary.

As best seen in FIGS. 1 and 4-7, one or more input fluid jets 34 having corresponding micronozzles 34a are aimed at the input 28 of channel 22. By way of example, micronozzle 34a is aimed at center 28a the input 28 and is capable of centric and eccentric aiming by displacements in the x and y directions, as well as, changes to the incoming angle in the x-z and x-z axes. It is further contemplated to provide one or more output fluid jets 36 having corresponding micronozzles 36a aimed at the output 32 of channel 22. Micronozzle 36a is aimed at center 32a of the output 32 and is capable of centric and eccentric aiming by displacements in the x and y directions, as well as, changes to the incoming angle in the x-z and x-z axes.

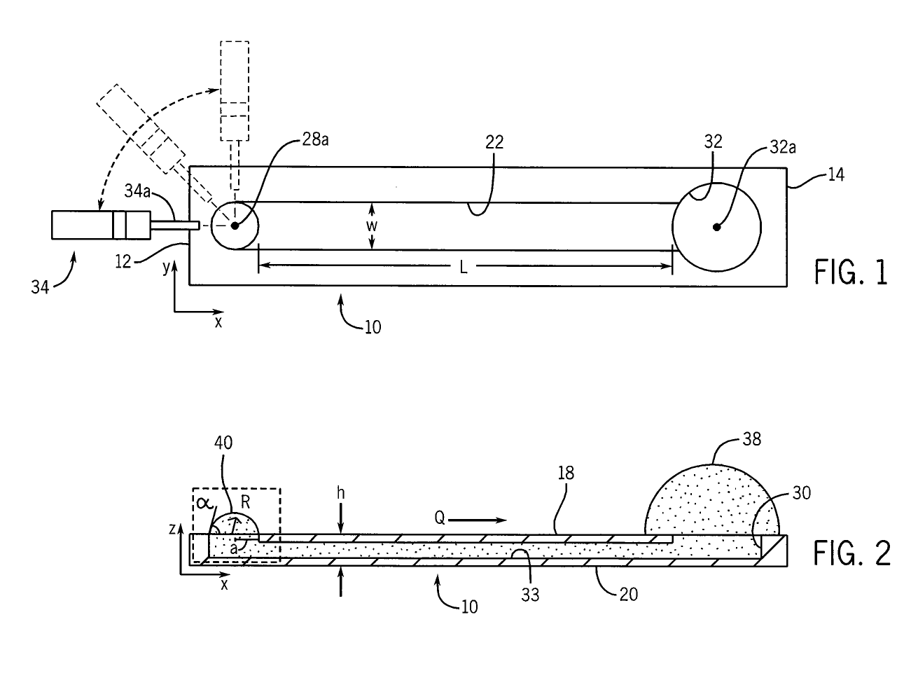

Referring to FIGS. 2 and 4-7, in the depicted embodiment, fluid is provided in channel 22 of microfluidic device 10. Large output drop 38 (e.g., 100 μL), is provided at output 32 of channel 22. The radius of output drop 38 is greater than the radius of output port 32 and is of sufficient dimension that the pressure at output 32 of channel 22 is essentially zero. An input drop 40, of significantly smaller dimension than output drop 38, (e.g., 0.5-5 μL), is deposited on input 28 of channel 22. Input drop 40 may be hemispherical in shape or may be other shapes. As such, it is contemplated that the shape and the volume of input drop 40 be defined by the hydrophobic/hydrophilic patterning on upper surface 18 of microfluidic device 10 surrounding input 28. As previously noted, microfluidic device 10 is formed from PDMS which has a high hydrophobicity and has a tendency to maintain the hemispherical shapes of input drop 40 and output drop 38 on input and output 28 and 32, respectively, of channel 22. It is contemplated as being within the scope of the present invention that the fluid in channel 22, input drop 40 and output drop 38 be the same liquid or different liquids.

The amount of pressure present within a drop of liquid at an air-liquid interface is given by the Young-LaPlace equation:

ΔP=γ(1/R1+1/R2) Equation (1)

wherein: γ is the surface free energy of the liquid; and R1 and R2 are the radii of curvature for two axes normal to each other that describe the curvature of the surface of the drop. For spherical drops, Equation (1) may be rewritten as:

ΔP=2γ/R Equation (2)

wherein: R is the radius of the drop.

Using trigonometric relations, the change in drop radius as a function of drop height is defined by:

R(t)=[H(t)²+(2a)²]/[2H(t)](1) Equation (3)

wherein: R(t) is the drop radius of a drop as a function of time t; H(t) is the drop height of the drop as a function of time t; and a is the drop wetted radius, which may be assumed to be equal to the radius of input 28 of channel 22, FIG. 2.

Theoretically, a drop, e.g. input drop 40, with a contact angle α of 90° with respect to input 28 of channel 22 creates maximum possible pressure. However, this pressure remains only for as long as input drop 40 is at 90° to the input 28 and it only takes milliseconds for a single drop to collapse. To maintain the flow rate associated with maximum pressure, a new drop has to be delivered to input 28 of channel 22 immediately before the collapse of the previous one. As hereinafter described, by using an automated delivery system to sequentially deliver drops to input 28 of channel 22, a semicontinuous flow in channel 22, close to the theoretical maximum flow rate, can be achieved.

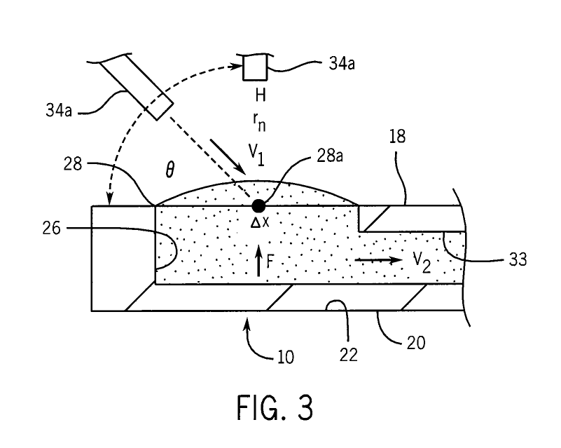

Referring to FIGS. 2-3, the momentum caused by a drop collapse in surface tension driven flow is much less than that carried by a stream of fluid ejecting out of micronozzle 34a of fluid jet 34 with significant backpressure. More specifically, it is noted that the velocity V₂ of fluid flowing through channel 22 may be calculated according to the equation:

V₂=Q/(hw) Equation (4)

wherein V₂ is the velocity of fluid flowing through channel 22; Q is the flow rate of the fluid through channel 22; h is the height of channel 22; and w is the width of channel 22. As a result, the relationship between the velocity V₂ of fluid flowing through channel 22 and the momentum of droplet 42 directed at input 28 in (x,y) coordinates may be expressed according to the expression:

(V₁² cos θρπr²−V₂²phw)î+(V₁² sin θρπr²+F)j=0 Equation (5)

wherein: V₂ is the velocity of fluid flowing through channel 22; ρ is the fluid density; θ is the angle between the axis of travel of droplet 42 and the plane in which input 28 of channel 22 lies; r is the inner radius of micronozzle 34a of fluid jet 34; V₁ is the velocity of droplet 42 directed at input 28 of channel 22; h is the height of the channel 22; w is the width of channel 22; î is the x-direction vector; F is the y-direction force on the bottom surface of input 28 of channel 22; and j is the y-direction vector.

Equation 5 specifies the balance of forces in the x and y directions and relates the incoming, high velocity droplet 42 produced by fluid jet 34 with the slower moving fluid flowing through channel 22 of microfluidic device 10. It can be appreciated that the dynamic pressure useful to generate fluid flow in channel 22 is the one that is transferred along the x direction, while the dynamic pressure on the y-axis is reflected back or dissipated around the impact area. The y-direction force F on the bottom surface of input 28 of channel 22 is pointed inward toward the system because this is the only direction that this force has any effect on the system.

The Reynolds number Re is used as a measure of how much of the momentum of droplet 42 is transferred to the fluid inside channel 22. A low Reynolds number Re indicates that little or no momentum is transferred to the fluid inside channel 22 and the flow of fluid in channel 22 is surface tension dominated. A high Reynolds number Re indicates that the momentum of droplet 42 is being transferred to the fluid inside of channel 22 and that the momentum of droplet 42 the dominant force on the flow of fluid in channel 22. It can be assumed that a Reynolds number Re of approximately 100 is indicative of the momentum of droplet 42 being the dominant force on the flow of fluid in channel 22. The Reynolds number, Re, may be calculated according to the expression:

Re=V₁²ρ²h³(1−0.63h/w)/(12μ²L) Equation (6)

wherein: Re is the Reynolds number; V₁ is the velocity of droplet 42 directed at input 28 of channel 22; ρ is the fluid density; h is the height of the channel 22; w is the width of channel 22; and L is the length of channel 22.

In view of the foregoing, it can be appreciated that higher back pressure on micronozzle 34a of fluid jet 34 results in higher fluid droplet velocities V₁ out of micronozzle. A low back pressure on micronozzle 34a of fluid jet 34 results in the formation of a droplet 42 at the tip of micronozzle 34a, which will eventually become big enough and drip into the inlet. Hence, the flow rate and fluid velocity V₁ out of micronozzle 34a dictates the flow rate and fluid velocity V₂ inside channel 22 of microfluidic device 10.

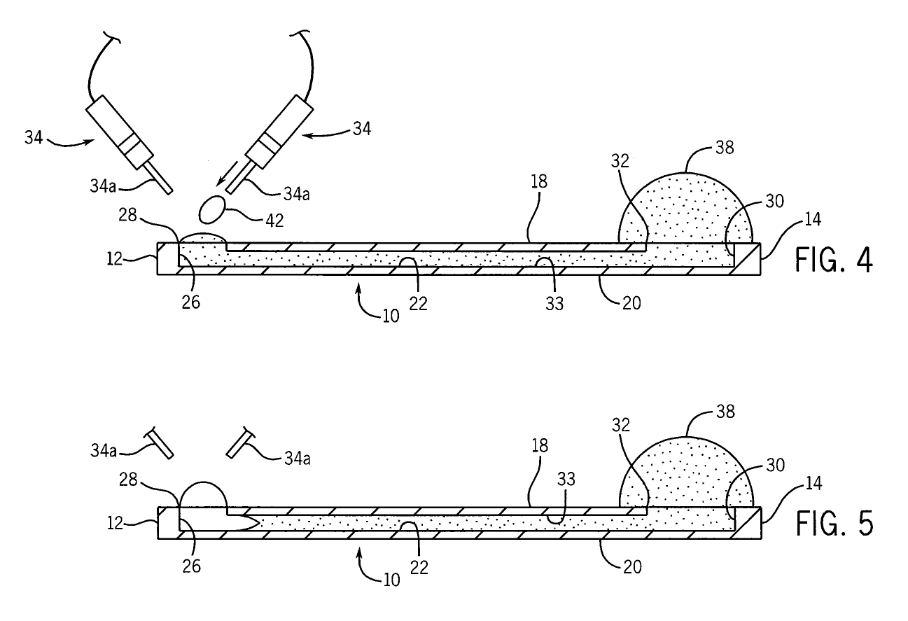

It can be appreciated that a plurality of fluid jets 34, FIGS. 4-7, may be used in parallel to control multiple fluids interacting at input 28 of channel 22 of microfluidic device 10. As previously described, the amount of fluid distributed by fluid jet 34 is a function of the back pressure on and open time of micronozzle 34a. For a given open time, an increase in back pressure results in increased flow rates out of micronozzle 34a of fluid jet 34. In general, smaller open times result in smaller droplets 42 being ejected from micronozzle 34a of fluid jet 34, whereas large open times result in streams of fluid being provided by micronozzle 34a of fluid jet 34.

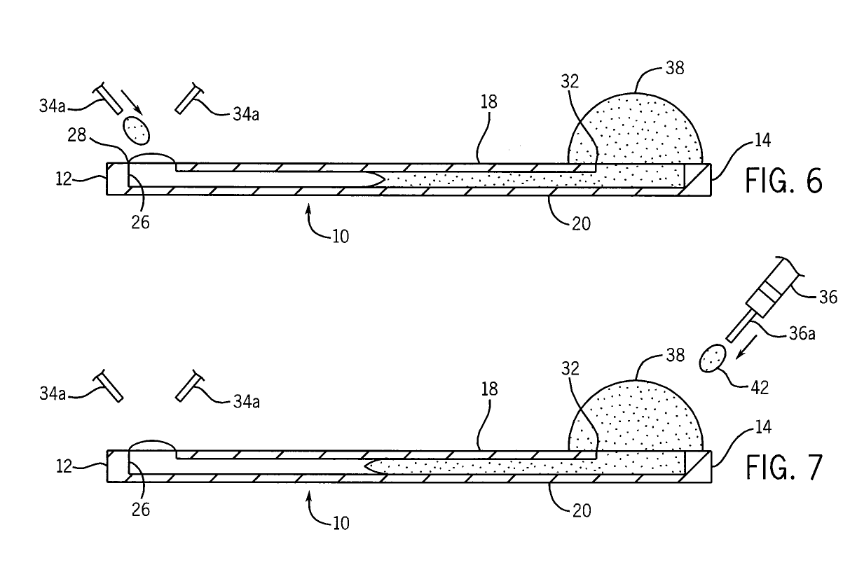

Referring to FIGS. 4-7, in order to generate fluid flow in channel 22 of microfluidic device 10, each fluid jet 34 is positioned adjacent microfluidic device 10 such that droplets 42 distributed by micronozzle 34a travel along an axis at an acute angle to input 28 of channel 22, and hence, to upper surface 18 of microfluidic device 10. By way of example, it is contemplated for droplets 42 to travel along an axis at an angle of approximately 40° to input 28 of channel 22 to maximize the momentum transfer and generate fluid flow in channel 22. The open and closed times of micronozzle 34a of fluid jet 34 are selected such that micronozzle 34a of fluid jet 34 delivers a high frequency sequence of droplets 42 to input 28 of channel 22. Given the momentum caused by the collapse of input drop 40 is less than the momentum of each droplet 42 generated by fluid jets 34, input drop 40 begins to flow from input 28 through channel 22 towards output 32 of channel 22, FIG. 5. It can be understood that by sequentially directing additional droplets 42 towards input 28 of channel 22, FIG. 6, input drop 40 continues to flow through channel 22 towards output 32 of channel 22. As a result, fluid flows through channel 22 from input 28 to output 32.

It can be appreciated that the constant flow of fluid from micronozzle 34a may be generated by eliminating the closed time and creating a stream of fluid rather than a sequence of droplets 42. By weighing the volume of droplets 42 distributed by fluid jet 34 through micronozzle 34a over a given period of time, one can estimate the actual fluid velocities V₁ of droplets 42 generated by micronozzle 34a, thereby allowing a user to tune microfluidic device 10 to generate a user-desired flow rate through channel 22.

Referring to FIG. 7, it is noted that methodology of the present invention does not require the presence of output drop 40 to generate fluid low in channel 22. Hence, it is contemplated for the one or more output fluid jets 36 having corresponding micronozzles 36a aimed at the output 32 of channel 22 to be used to generate fluid flow from output 32 of channel 22 towards input 28 of channel 22. More specifically, each output fluid jet 36 is positioned adjacent microfluidic device 10 such that the droplets distributed by micronozzle 36a travel along an axis at an acute angle to output 32 of channel 22, and hence, to upper surface 18 of microfluidic device 10. By way of example, it is contemplated for the droplets to travel along an axis at an angle of approximately 40° to output 32 of channel 22 to maximize the momentum transfer and generate fluid flow in channel 22, in the manner heretofore described.

In addition to generating fluid flow in channel 22, it is contemplated to use the device and methodology of the present invention to induce mixing of two fluids at input 28 of channel 22. This is accomplished using the momentum carried by directing droplets 42 from each of fluid jets 34 simultaneous at input 28 of channel 22 to perform on-the fly mixing of two or more liquid components of the droplets 42. Collison dynamics studies show how eccentric collision of droplets aids in the merging of the two liquid components of the droplets. More specifically, a mixing swirl can be caused by aiming micronozzles 34a of first and second fluid jets 34 eccentrically at input 28 of channel 22. Droplets 42 directed at input 28 of channel 22 products high rotational velocities of the fluid at input 28 of channel 22, but the overall flow rate of the fluid through channel 22 is still relatively low. It is noted that individual droplets 42 must be delivered to input 28 of channel 22 instead of constant streams because overflow will occur if the incoming volumetric flow rate at input 28 is too great.

Further, it can be appreciated that by positioning two fluid jets 34, both aimed at the same angle to input 28 of channel 22, whole channel fluidic exchange may be done in fractions of a second by taking advantage of high shear stresses generated near the channel wall. The time it takes to do whole channel fluidic exchange is proportional to the back pressure on the micronozzles 34a of fluid jets 34. More specifically, a high back pressure results in high intra-channel fluid velocities, and therefore, high shear stresses.

The device 10 and methodology of the present invention bring more functionality to surface tension passive pumping in open systems by allowing implementation of such techniques as on-the fly mixing at the inlet, fast fluidic exchanges inside the channel and instantaneous reversal of flow, as heretofore described. It is further noted that the high velocity stream from micronozzle 34a directed towards input 28, as heretofore described, causes a low pressure region in the fluid at input 28 of channel 22. This low pressure region will aspirate any fluid, other than the stream from micronozzle 34a, placed therein by manual or automated means. As such, by providing the low pressure region in the fluid at input 28, a user has the ability to flow suspensions (i.e., suspensions including particles, cells, aggregates, solid chemicals, liquid chemicals and/or the like) directly through channel 22 without having to pass through fluid jet 34. Hence, a suspension may by taken directly from a recipient and immediately flowed through channel 22 of microfluidic device 10.

It is further contemplated to utilize fluid jet 34 to fill channel 22 of microfluidic device 10 with fluid. More specifically, in order to fill empty channel 22, fluid jet 34 is positioned adjacent microfluidic device 10 such that droplets 42 distributed by micronozzle 34a travel along an axis at an angle to input 28 of channel 22, and hence, to upper surface 18 of microfluidic device 10 such that the axis intersects one of the walls defining channel 22. As is known, droplets 42 directed at the wall of channel 22 have a dynamic pressure related to the velocity of droplets 42. In addition, an adhesion force is provided between the fluid received in channel 22 and the wall of channel 22. If the velocity (and hence, the dynamic pressure) of droplets 42 entering channel 22 is low enough, it can be appreciated that the adhesion force between the fluid in channel 22 and the wall of channel 22 will be greater than the dynamic pressure of droplets 42, thereby resulting in the filling of channel 22 by droplets 42 distributed by micronozzle 34a.

Alternatively, it is further contemplated to utilize fluid jet 34 to empty channel 22 of microfluidic device 10 of fluid. More specifically, in order to empty channel 22, fluid jet 34 is positioned adjacent microfluidic device 10 such that droplets 42 distributed by micronozzle 34a travel along an axis at an angle to input 28 of channel 22 such that the axis (and hence, droplets 42) does not intersect any of the walls defining channel 22. As previously described, the droplets 42 directed at channel 22 have a dynamic pressure related to the velocity of droplets 42 and an adhesion force is provided between the fluid received in channel 22 and the wall of channel 22. If the velocity (and hence, the dynamic pressure) of droplets 42 entering channel 22 substantially exceeds the adhesion force between the fluid in channel 22 and the wall of channel 22, droplets 42 distributed by micronozzle 34a clear channel 22 of fluid. A partial emptying of channel 22 may occur (assuming the same high dynamic pressure) if droplets 42 engage a wall of channel 22.

Various modes of carrying out the invention are contemplated as being within the scope of the following claims particularly pointing out and distinctly claiming the subject matter, which is regarded as the invention.

We claim:

1. A device for the surface tension pumping of fluid though a channel of a microfluidic device, the channel including an input and an output, comprising:
a first fluid received in the channel, the first fluid having an input air-fluid interface at the input of the channel and an output air-fluid interface at the output of the channel; and
a fluid jet at a user selected angle to the input air-fluid interface, the fluid jet selectively directing a second fluid under pressure at the input air-fluid interface of the first fluid so as to cause fluid flow in the channel towards the output.

2. The device of claim 1 wherein the fluid jet is a first fluid jet and wherein the device further comprises a second fluid jet at a user selected angle to the output air-fluid interface, the second fluid jet selectively directing a third fluid under pressure at the output air-fluid interface of the first fluid so as to cause fluid flow in the channel towards the input.

3. The device of claim 2 wherein the input and output of the channel lie in corresponding planes and wherein the first fluid jet is at an angle of less than 90 degrees to the plane of the input and the second fluid jet is at an angle of less than 90 degrees to the plane of the output.

4. The device of claim 1 wherein the input of the channel lies in a plane and wherein the fluid jet is at an angle of less than 90 degrees to the plane.

5. The device of claim 1 wherein the second fluid is at least partially defined by a first droplet and wherein the fluid jet directs a series of droplets under pressure at the input air-fluid interface of the first fluid.

6. The device of claim 1 wherein the fluid jet is a first fluid jet and wherein the device further comprises a second fluid jet at a user selected angle to the input air-fluid interface, the second fluid jet directing a third fluid under pressure at the input air-fluid interface of the fluid.

7. The device of claim 6 wherein the second fluid directed by the first fluid jet is spaced in time from the third fluid directed by the second fluid jet.

8. The device of claim 1 wherein the fluid jet includes a nozzle, the nozzle being spaced from the input air-fluid interface.

9. A method of pumping fluid, comprising the steps of:
providing a microfluidic device having a channel therethough, the channel having an input and an output;
filing the channel with a first fluid; and
selectively directing a second fluid under pressure at the input of the channel so as to cause fluid flow in the channel towards the output.

10. The method of claim 9 comprising the additional step of selectively directing a third fluid under pressure at the output of the channel so as to cause fluid flow in the channel towards the input.

11. The method of claim 10 wherein the input and output of the channel lie in corresponding planes and wherein the second fluid directed at the input travels along an axis at an angle of less than 90 degrees to the plane of the input and the third fluid directed at the output travels along an axis at an angle of less than 90 degrees to the plane of the output.

12. The method of claim 9 wherein the input of the channel lies in a plane and wherein the second fluid directed at the input travels along an axis at an angle of less than 90 degrees to the plane of the input.

13. The method of claim 9 wherein the second fluid is at least partially defined by a first droplet and wherein the method includes the additional step of directing a series of droplets under pressure at the input of the channel.

14. The method of claim 9 wherein the second fluid is at least partially defined by a first droplet and the first droplet is directed by a first fluid jet and wherein the method comprises the additional step of selectively directing a second droplet under pressure at the input of the channel by a second fluid jet.

15. The method of claim 14 wherein the first droplet directed by the first fluid jet is spaced in time from the second droplet directed by the second fluid jet.

16. A method of pumping fluid through a channel of a microfluidic device, the channel having an input and an output, comprising the steps of:
filling the channel with a first fluid such that the first fluid at the input has a surface tension pressure; and
selectively directing a volume of a second fluid under pressure at the input of the channel so as to cause fluid in the channel to flow towards the output.

17. The method of claim 16 wherein the step of selectively directing a volume of the second fluid under pressure at the input of the channel includes the steps of sequentially directing a plurality of droplets under pressure at the input of the channel.

18. The method of claim 17 comprising the additional step of selectively directing a plurality of droplets under pressure at the output of the channel so as to cause fluid in the channel to flow towards the input.

19. The method of claim 18 wherein the input and output of the channel lie in corresponding planes and wherein each droplet directed at the input travels along an axis at an angle of less than 90 degrees to the plane of the input and each droplet directed at the output travels along an axis at an angle of less than 90 degrees to the plane of the output.

20. The method of claim 17 wherein the input of the channel lies in a plane and wherein each droplet directed at the input travels along an axis at an angle of less than 90 degrees to the plane of the input.

21. The method of claim 17 wherein each droplet directed under pressure at the input of the channel is directed by a first fluid jet.

22. The method of claim 21 further comprising the additional step of selectively directing a second plurality of droplets under pressure at the input of the channel by a second fluid jet.

23. The method of claim 22 wherein each droplet directed by the first fluid jet is spaced in time from each droplet directed by the second fluid jet.

24. The method of claim 16 wherein the channel is defined by a wall and wherein the step of filling the channel includes the additional step of directing a volume of the first fluid under pressure at the wall of the channel such that the channel is filled with the fluid.

25. The method of claim 24 wherein:
the volume of first fluid is directed at the wall of the channel has a dynamic pressure;
an adhesion force is provided between the first fluid in the channel and the wall of the channel; and
the adhesion force is greater than the dynamic pressure.

26. The method of claim 16 wherein:
the channel has a boundary;
an adhesion force is provided between the first fluid in the channel and the boundary of the channel;
the volume of the second fluid has a dynamic pressure;
the volume of the second fluid directed at the input of channel travels along an axis free of contact with the boundary; and
the dynamic pressure of the volume of the second fluid overcomes the adhesion force.

27. A method of pumping fluid, comprising the steps of:
providing a microfluidic device having a channel therethough, the channel having an input and an output;
filing the channel with a first fluid;
creating a low pressure region in the first fluid at the input of the channel; and
selectively providing a second fluid at the low pressure region in the first fluid at the input of the channel such that the second fluid flows in the channel towards the output.

28. The method of claim 27 wherein the second fluid is a suspension.

29. The method of claim 27 wherein the step of creating a low pressure region includes the step of directing a droplet under pressure at the input of the channel.
